(19) United States
(12) Patent Application Publication
(10) Pub. No.: US 2020/0224926 A1
(43) Pub. Date: Jul. 16, 2020

(54) AIR HEATING DEVICE FOR A VEHICLE

(71) Applicant: Webasto SE, Stockdorf (DE)

(72) Inventors: MARTIN ZOSKE, Stockdorf (DE); VOLODYMYR ILCHENKO, Stockdorf (DE); UWE STRECKER, Stockdorf (DE); BENGT MEIER, Stockdorf (DE); NIKOLAUS GERHARDT, Stockdorf (DE); MICHAEL SCHWANECKE, Stockdorf (DE); MANFRED GRUBER, Dobl-Zwaring (AT); CHRISTIAN KUSSMANN, Dobl-Zwaring (AT)

(21) Appl. No.: 16/615,090

(22) PCT Filed: May 8, 2018
(86) PCT No.: PCT/EP2018/061813

§ 371 Date: Nov. 19, 2019

(30) Foreign Application Priority Data
May 24, 2017 (DE) 10 2017 111 373.8
May 24, 2017 (DE) 10 2017 111 378.9
Jul. 6, 2017 (DE) 10 2017 115 148.6
Sep. 12, 2017 (DE) 10 2017 121 040.7

(51) Int. Cl. F24H 3/04; B60H 1/22; H05B 3/06; H05B 3/14

(52) U.S. Cl. CPC F24H 3/0429; B60H 1/2225; H05B 2203/017; H05B 3/145; H05B 3/06

(57) ABSTRACT

An electric air heating device for a vehicle, specifically a motor vehicle, preferably a private car or a heavy goods vehicle, including at least a first heating element around which the air to be heated flows, wherein the first heating element comprises a preferably electrically-insulating substrate and at least one electrically-conductive carbon-based coating, specifically a polymer coating.

### CROSS-REFERENCE TO RELATED APPLICATIONS

This application represents the national stage entry of PCT International Patent Application No. PCT/EP2018/061813 filed on May 8, 2018 and claims priority to German Patent Application No. DE 10 2017 111 373.8 filed May 24, 2017, to German Patent Application No. DE 10 2017 111 378.9 filed May 24, 2017, German Patent Application No. DE 10 2017 115 148.6 filed Jul. 6, 2017, and German Patent Application No. DE 10 2017 121 040.7 filed Sep. 12, 2017. The contents of each of these applications are hereby incorporated by reference as if set forth in their entirety herein.

### DESCRIPTION

The disclosure relates to an air heating device, specifically for a vehicle, preferably a motor vehicle.

Electric air heating devices (specifically those employed in mobile applications) are generally based upon ceramic heating elements having a comparatively high temperature-dependent electrical resistance, by means of which a self-regulated heat output is permitted. These resistors are customarily ceramic PTC elements (PTC: Positive Temperature Coefficient). These are generally connected to heat transfer surfaces of sheet aluminium, and are also electrically contacted by means thereof. A PTC element comprises a PTC resistor, i.e. a temperature-dependent resistor with a positive temperature coefficient, which conducts electric current better at low temperatures than at high temperatures.

Disadvantages of conventional air heating devices having ceramic PTC elements include, inter alia, the expense of manufacture associated with the production of a comparatively complex heat exchanger and the incorporation of ceramic elements, the sorting of ceramic elements which is customarily required on the grounds of manufacturing tolerances, the comparatively unfavourable power density of a heating element/heat exchanger combination associated with localized heat generation, the comparatively severe restriction of maximum heating power associated with the thickness of the PTC material (associated with the limited evacuation of heat from the ceramic material), and a comparatively high short-circuit risk, specifically on the grounds of a small geometrical clearance between components having a high voltage difference.

The object of the disclosure is the proposal of an air heating device which enables the effective heating of air. Specifically, it is intended to permit a high power density in a comparatively small structural space. A further object of the disclosure is the proposal of a corresponding method for operating an air heating device, and a method for the manufacture thereof.

This object is specifically solved by an electric air heating device according to Claim 1.

Specifically, this object is solved by an electric air heating device, preferably for a vehicle, further preferably for a motor vehicle, and further preferably still for a private car or a heavy goods vehicle, comprising at least a first heating element around which air to be heated flows, wherein the first heating element comprises a preferably electrically-insulating substrate and at least one electrically-conductive carbon-based coating, specifically a polymer coating (by way of a heat conductor).

A key concept of the disclosure involves the employment of fundamentally known (e.g. from DE 689 23 455 T2) conductive coatings having a carbon component in a vehicle air heating device. The substrate specifically functions as a heat-exchanger. Preferably, the carbon-based coating is configured to assume a (strong) positive temperature coefficient (and thus possesses a certain self-regulating property). By means of this coating, a large (active) heatable surface area can be achieved, as a result of which the requisite surface temperature can be reduced, whilst maintaining the same overall heating power and the same overall structural space. Accordingly, at (maximum) surface temperatures of less than 200° C., overall heating power of up to 4 kW, or higher, are nevertheless conceivable (in customary structural spaces for vehicle air heating devices, specifically motor vehicle air heating devices).

It has also been recognized that comparatively low maximum temperatures permit the use of (comparatively cost-effective and easily-produced) plastics by way of a substrate (carrier) and optionally as a heat transfer material. The substrate (carrier), for example, can thus be cost-effectively produced, optionally as a one-piece component using an injection-moulding method, e.g. from a temperature-resistant plastic such as polyethylene (PE) and/or polypropylene (PP) and/or polyether ether ketone (PEEK) and/or optionally a (short-) fibre-reinforced polyamide (e.g. PA-GF).

An additional protective mechanism can optionally be provided against overheating by means of a localized foaming of the carrier material (substrate) in the event of an uncontrolled increase in temperature, and the associated mechanical destruction or interruption of the conductive coating.

Contacting of the (conductive) carbon-based coating can be achieved, for example, by means of (curved) sheet copper contacts, which lie in contact with the respective coating.

For protection against mechanical damage, moisture and/or short-circuits, the device (air heating device) can be lacquered (optionally in its entirety).

The first heating element is configured for immersion in a flux of air to be heated, which specifically signifies that the heating element at least partially constitutes a fluid duct (through which the air which is to be heated can flow).

In general, the electric air heating device comprises one or more fluid ducts for the feedthrough of air to be heated. These fluid ducts can specifically assume a polygonal, specifically a quadrangular, and preferably a rectangular cross-section (perpendicularly to a direction of flow). Alternatively, the one or more fluid ducts can assume an (at least essentially) round, and specifically a circular cross-section.

The carbon-based coating can be constituted by the application of a corresponding carbon-based thermal conductive paste. For example, this thermal conductive paste can be constituted as proposed in Table I on page 11 of DE 689 23 455 T2.

The carbon-based coating can be applied to (imprinted onto) the substrate by a coating and/or imprinting method. Optionally, a curing stage can be executed at an increased temperature (e.g. in excess of 120° C.) in a kiln. For imprinting, for example, a screen-printing or blade coating method can be employed. Carbon in the carbon-based coating can be present, for example, in the form of carbon black or in the form of graphite.

In general, the carbon-based coating, or a paste employed for the production of the carbon-based coating, can be constituted as described in DE 689 23 455 T2. This also applies specifically to the production and/or the specific composition thereof. For example, the same also applies to potential bonding agents (specifically in accordance with page 4, 2^{nd} paragraph and page 5, 1^{st} paragraph of DE 689 23 455 T2) and/or solvents (specifically in accordance with page 5, 2^{nd} paragraph and page 6, 2^{nd} paragraph of DE 689 23 455 T2).

The substrate can simultaneously be employed as a heat transfer surface for the heat-up of the passing stream of air. Optionally, this surface can be further enlarged by means of irregularities, specifically projections, such as ribs and/or fins on the substrate.

Overall, by means of comparatively simple producibility and the option for the employment of cost-effective materials, an air heating device which can be cost-effectively produced is proposed. By means of a highly active heatable surface, a high power density can be achieved in the available structural space. Safety which is comparable to that of conventional ceramic PTC heaters can be achieved by an optionally self-regulating heated coating. By the (optional) fusion of material, an additional safety effect can be achieved. On the grounds of an optionally small potential difference from adjoining components, there is no, or only a comparatively small short-circuit risk.

Preferably, at least one second heating element is provided, wherein the second heating element comprises a second substrate and at least one second electrically-conductive (carbon-based) coating, specifically a polymer coating (by way of a heat conductor). An interspace is preferably constituted between the two heating elements, through which a flux of air can be directed for the heating thereof.

The substrate or the substrates, at least in part, or preferably entirely, can be produced from a plastic, specifically a polymer such as, for example, polyether ketone and/or polyamide. The production thereof from polyethylene (PE) and/or polypropylene (PP) and/or polyether ether ketone (PEEK) and/or (short-) fibre-reinforced polyamide (e.g. PA-GF) is specifically preferred.

The substrate can be formed of an electrically-insulating material. An electrically-insulating material is specifically to be understood as a material which, at room temperature (25° C.), has an electrical conductivity of less than 10⁻¹ S·m⁻¹ (optionally less than 10⁻⁸ S·m⁻¹). Correspondingly, an electrical conductor or a material (or coating) having electrical conductivity is specifically to be understood as a material which has an electrical conductivity of preferably at least 10 S·m⁻¹, or further preferably at least 10³ S·m⁻¹ (at a specific room temperature of 25° C.).

The substrate can be formed of a material which foams and/or melts at a temperature below 500° C., preferably below 200° C.

The carbon-based coating or carbon-based coatings can be (electrically) contacted by means of at least one metal structure, preferably a (specifically curved) sheet metal, preferably sheet copper, and/or metal strips and/or metal wire and/or a metal grating.

Alternatively or additionally, the metal structure (or the corresponding electrodes) can be imprinted e.g. onto the substrate and/or the polymer coating.

Alternatively or additionally, the metal structure (or the corresponding electrodes) can be applied e.g. to the substrate and/or to the polymer coating by imprinting or vapour deposition.

Alternatively or additionally, the metal structure (or the corresponding electrodes) can be applied e.g. to the substrate and/or to the polymer coating by means of a coating process. The carbon-based polymer coating or carbon-based polymer coatings and/or a corresponding paste for the production thereof can (specifically by way of a crystalline bonding agent) comprise at least one polymer, preferably based upon at least one olefin, and/or at least one copolymer of at least one olefin and at least one monomer, which can be copolymerized therewith, e.g. ethylene/acrylic acid and/or ethylene/ethyl acrylate and/or ethylene/vinyl acetate, and/or at least one polyalkenamer (polyacetylene or polyalkenylene), such as e.g. polyoctenamer, and/or at least one, specifically melt-mouldable, fluoropolymer such as, e.g. polyvinylidene fluoride and/or copolymers thereof.

The carbon-based polymer coating or carbon-based polymer coatings are preferably applied to the (respective) substrate by imprinting (e.g. by screen printing) or by blade coating.

Moreover, the carbon-based coating, specifically the polymer coating, or carbon-based coatings, specifically polymer coatings, can be cured in a kiln (at an increased temperature).

In general, the carbon-based coating or the carbon-based coatings can constitute a continuous surface (with no interruptions), or can be structured, for example by the incorporation of gaps (penetrations) or recesses.

The carbon in the carbon-based coating or in the carbon-based coatings can be present in particle form, specifically in the form of particles of carbon black. Alternatively or additionally, carbon can be present in the form of a carbon matrix (or skeleton).

Carbon can be present in the form of carbon black and/or graphite and/or graphene and/or carbon fibres and/or carbon nanotubes.

Preferably, the carbon-based coating comprises at least 5% by weight, preferably at least 10% by weight, further preferably at least 15% by weight, further preferably at least 20% by weight and/or less than 50% carbon (optionally excluding any carbon component of the polymer per se) or carbon constituents such as, e.g. carbon particles.

The first and/or second heating element can (at least essentially) extend along a direction of air flow and/or extend at an angle vis-à-vis the direction of air flow, for example at an angle equal to or smaller than 90° and greater than 0°, specifically greater than 10°. Preferably, in the event of extension at an angle (greater than 0°) vis-à-vis the direction of air flow, comparatively narrow heating elements can preferably be employed (i.e. heating elements, the width of which is comparatively small in relation to their length, for example smaller than 0.2-times or 0.1-times said length). The width of the respective heating element can extend in a direction of flow. At least one of the heating elements (preferably a plurality or all of the heating elements) is (are) preferably shorter in the direction of flow than in a direction which is perpendicular thereto, e.g. 50% shorter.

An outline of the respective heating element (preferably of a plurality or all the heating elements) can be polygonal, specifically quadrangular, preferably rectangular or oval, specifically elliptical, and preferably round (circular).

At least one interspace (optionally a plurality or all the interspaces) can be delimited by (exactly) two or more heating elements.

A cross-section of the interspace (generally of the air duct) can be polygonal, specifically quadrangular, preferably rectangular or oval, specifically elliptical, and preferably round (circular).

An internal cross-section of an interspace (air duct) can vary or can be constant (over the length thereof). Cross-sections of different interspaces or air ducts (i.e. interspaces or air ducts which are not constituted by the same pair or the same group of heating elements) can also deviate from one another, or can be identical. For example, cross-sections of the interspaces or air ducts can be configured with a slot shape (specifically as rectangular slots).

The respective carbon-based coating (of at least one of the heating elements, preferably of a plurality or all the heating elements) can (at least in cross-section) be thinner than the corresponding substrate, for example by a factor of 1.1, and further preferably by a factor of 1.5.

In principle, the term “conductive”, applied with respect to conductive components of the air heating device, is to be understood as shorthand for “electrically conductive”.

The (respective) carbon-based coating is preferably a conductive layer with PTC properties.

The air heating device is preferably designed for operation in a low-voltage range (e.g. ≤100 volts or ≤60 volts).

The air heating device can be designed for operation with a direct and/or alternating voltage, and/or for PWM.

The substrate or substrates can be configured as a plate, specifically a plastic plate, and/or can assume a thickness of at least 0.1 mm, preferably at least 0.5 mm, further preferably at least 1.0 mm and/or no more than 5.0 mm, further preferably no more than 3.0 mm. The respective thickness is specifically an average thickness, or a thickness of the largest region having a constant thickness.

A (film) thickness of the respective carbon-based coating can be ≤1 mm, preferably ≤0.5 mm, and further preferably ≤0.2 mm.

The first and/or second carbon-based coating and/or the substrate (or substrates) can be at least essentially of a planar configuration. If any projections (or recesses) are provided, these can constitute less than 10% of an (average) thickness of the respective coating or the respective substrate.

A sum of the cross-sections of the fluid ducts (specifically of the interspaces between the heating elements) can be at least two times, preferably at least four times greater than the sum of the cross-sections of the heating elements (specifically considered transversely to the direction of air flow, or transversely to a lateral direction).

The carbon content of the carbon-based coating of at least one heating element (preferably of a plurality or all the heating elements) can be configured such that it permits a flow of current (e.g. in particle form), wherein the particles are correspondingly in contact or mutually adjacent to one another.

At least three, preferably at least five heating elements (optionally with corresponding interspaces) can be provided.

A diameter of the interspace between the first and the second heating element can be greater than a thickness of the first and/or the second heating element.

The (respective) carbon-based coating is preferably in contact to a proportion of at least 20%, further preferably at least 50%, or further preferably at least 80% with the (respective) substrate at a surface of said substrate which faces the carbon-based coating. Transfer can thus be effectively executed by the substrate (which then functions as a further heat exchanger).

The above-mentioned object is further fulfilled by a method for operating an air heating device of the above-mentioned type, wherein air at least flows past the first heating element, specifically through the at least one interspace, and is heated accordingly.

According to a further aspect of the disclosure, a method (or methods) for producing an electric air heating device of the above-mentioned type is (are) proposed. Preferably, the first and/or second carbon-based coating is applied to the first or second substrate, specifically by screen-printing, and/or by blade coating and/or by spraying and/or by immersive application. The first and/or second substrate (or any further optionally provided substrates) can preferably be injection-moulded. Curing of the (respective) carbon-based coating can be executed in a kiln (at an increased temperature). A metal contacting structure (or corresponding electrodes) can be imprinted e.g. onto the substrate and/or the polymer coating and/or applied thereto by vapour deposition and/or by coating.

According to a further aspect of the disclosure, it is proposed that an air heating device of the above-mentioned type is employed for the heating of air in a vehicle, specifically in a motor vehicle, preferably in a passenger compartment of a motor vehicle.

According to a further aspect of the disclosure, it is proposed that a carbon-based coating is employed for the heating of air in a vehicle, specifically a motor vehicle, preferably in a passenger compartment of a motor vehicle. The carbon-based coating is specifically configured as described above.

Further forms of embodiment proceed from the sub-claims.

The disclosure is described hereinafter with reference to exemplary embodiments, which are elaborated in greater detail with reference to the attached figures. In the figures:

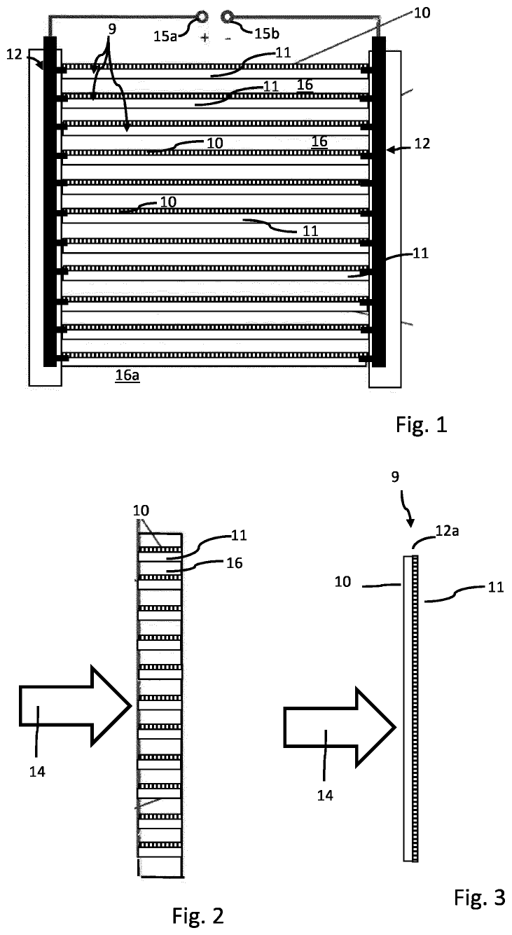

FIG. 1 shows a schematic frontal view of an electric air heating device according to the disclosure;

FIG. 2 shows a schematic side view of the embodiment according to FIG. 1, in a cross-sectional representation; and

FIG. 3 shows a schematic side view of an alternative embodiment of an electric air heating device according to the disclosure, in a cross-sectional representation which is analogous to FIG. 2.

In the following description, identical or identically-functioning components are identified by the same reference numbers.

FIG. 1 shows a frontal view of an air heating device according to the disclosure. This comprises a plurality (specifically eleven, although this is not mandatory) of heating elements 9. Each of the heating elements 9 comprises a conductive carbon-based layer 10 and a plastic substrate 11. The respective carbon-based layer 10 is connected to electrical contacts 15a, 15b by means of sheet metal 12 (specifically: curved sheet metal, preferably sheet copper). Interspaces (fluid ducts) 16 are configured between the heating elements 9. Air flows through these interspaces 16 for the purposes of the heating thereof (in FIG. 1, into the image plane or out of the image plane). A further interspace 16a can optionally be provided outside an (edge-mounted) heating element (in FIG. 1, the bottommost heating element). This further interspace 16a can then, for example, be delimited on the other side by a wall (e.g. a housing wall).

In the cross-sectional representation according to FIG. 2, the air flow is further specifically indicated by an arrow 14.

The alternative embodiment according to FIG. 3 is distinguished from the embodiment according to FIG. 1 in that the heating elements, in this case, do not extend along the direction of air flow (see FIG. 2), but perpendicularly thereto such that, in the representation according to FIG. 3, only one heating element 9 is visible, as the remaining heating elements are concealed by this heating element. Here again, for example, a plurality of heating elements (e.g. eleven) can be present. The interspaces are also concealed by the heating element 9.

At this point, it is observed that all the above-mentioned elements, considered individually per se or in any combination, specifically the details thereof represented in the drawings, are claimed as key to the disclosure. Variations herefrom will be familiar to a person skilled in the art.

### LIST OF REFERENCE NUMBERS

9 Heating element
10 Conductive carbon-based layer
11 Plastic substrate
12 Sheet metal
14 Arrow
15a Contact
15b Contact
16 Interspace (fluid duct)
16a Interspace (fluid duct)

1. Electric air heating device for a vehicle, comprising at least a first heating element around which the air to be heated flows, wherein the first heating element comprises an electrically-insulating substrate and at least one electrically-conductive carbon-based coating.

2. Air heating device according to claim 1, wherein at least one second heating element is provided, wherein the second heating element comprises a second substrate (11) and at least one second electrically-conductive carbon-based coating wherein an interspace is constituted between the heating elements, through which a flux of air can be directed for the heating thereof.

3. Air heating device according to claim 1, wherein the substrate or the substrates, at least in part, are produced from a polymer and/or from an electrically-insulating material and/or from a material which foams and/or melts at a temperature below 500° C.

4. Air heating device according to claim 1, wherein the carbon-based coating or the carbon-based coatings are electrically contacted by at least one metal structure.

5. Air heating device according to claim 1, wherein the carbon-based polymer coating or the carbon-based polymer coatings and/or a paste for the production of the respective carbon-based layer comprise at least one polymer, based upon
at least one olefin; and/or
at least one copolymer of at least one olefin and at least one monomer, which can be copolymerized therewith, e.g. ethylene/acrylic acid and/or ethylene/ethyl acrylate and/or ethylene/vinyl acetate; and/or
at least one polyalkenamer (polyacetylene or polyalkenylene); and/or
at least one melt-mouldable fluoropolymer.

6. Air heating device according to claim 1, wherein the carbon-based coating is imprinted onto the respective substrate or applied by blade coating, or is/are applied by spraying or immersion.

7. Air heating device according to claim 1,
wherein
the carbon in the carbon-based coating or in the carbon-based coatings is present in the form of particles of carbon black, and/or in the form of a carbon matrix and/or in the form of carbon black and/or graphite and/or graphene and/or carbon fibres and/or carbon nanotubes.

8. Air heating device according to claim 1,
wherein
the first and/or second heating element at least essentially extends along a direction of air flow and/or extends at an angle vis-à-vis the direction of air flow equal to or smaller than 90° and greater than 0°, specifically greater than 10°.

9. Air heating device according to claim 1,
wherein
the substrate or substrates is/are configured as a plate and/or assumes/assume a thickness of at least 0.1 mm and/or no more than 5.0 mm.

10. Air heating device according to claim 1,
wherein
the first and/or second carbon-based coating and/or the substrate or are configured to be at least essentially planar.

11. Air heating device according to claim 1,
wherein
at least three heating elements are provided, and/or a diameter of the interspace between the first and the second heating element is greater than a thickness of the first and/or second heating element.

12. Air heating device according to claim 1,
wherein
the carbon-based coating is in contact to a proportion of at least 20% with the substrate at a surface of said substrate which faces the carbon-based coating.

13. Method for operating an air heating device according to claim 1, wherein air at least flows past the first heating element through the at least one interspace, and is heated accordingly.

14. Method for producing an electric air heating device according to claim 1, wherein the first and/or second carbon-based coating is/are preferably imprinted onto the first or second substrate by screen-printing, and/or applied by blade coating and/or applied by spraying and/or by immersion, and/or wherein the first and/or second substrate is/are preferably injection-moulded.

15. Employment of an air heating device according to claim 1, and/or of a carbon-based coating, for the heating of air in a vehicle.

16. Vehicle comprising an air heating device according to claim 1.

17. Electric air heating device according to claim 1, wherein the at least one electrically-conductive carbon-based coating is a polymer coating.

18. Air heating device according to claim 3, wherein the polymer is a polyethylene and/or polypropylene and/or polyether ketone and/or polyamide.

19. Air heating device according to claim 4, wherein the at least one metal structure is a sheet metal, and/or metal strips and/or metal wire and/or a metal grating, and/or a metal structure which is applied by means of imprinting and/or vapour deposition, specifically a metal coating.

20. Air heating device according to claim 5, wherein the at least one melt-mouldable fluoropolymer is a polyvinylidene fluoride and/or copolymers thereof.
